(19) United States
(12) Patent Application Publication
(10) Pub. No.: US 2018/0260802 A1
(43) Pub. Date: Sep. 13, 2018

(54) BAG RECYCLING PROGRAM

(71) Applicant: Walmart Apollo, LLC, Bentonville, AR (US)

(72) Inventors: Douglas E. Humphrys, Bentonville, AR (US); Stephen Tyler Caution, Bentonville, AR (US); Yurgis Mauro Bacallao, Centerton, AR (US)

(21) Appl. No.: 15/913,174

(22) Filed: Mar. 6, 2018

Related U.S. Application Data
(60) Provisional application No. 62/468,211, filed on Mar. 7, 2017.

(51) Int. Cl. G06Q 20/24; G06K 19/06; G06K 19/07; A45C 3/04

(52) U.S. Cl. CPC G06Q 20/24; G06K 19/06018; A45C 3/04; G06K 19/0723; G06K 19/06037

(57) ABSTRACT

A system is described for making use of recycled containers, such as recyclable bags. The shopper first opts into a reusable bag recycling program using a computing device, such as a smartphone. The shopper may select and purchase products through an e-commerce system. The e-commerce system determines if the shopper has allergies and if so, either provides a non-allergenic reusable bag to shopper, or uses non-allergenic bags to package the products purchased through the e-commerce system. If the shopper does not have allergies, then a standard reusable bag will be used. An automated dispensing unit receives reusable bags, authenticates, tests, sanitizes and stores the reusable bags. Credit is provided to shopper for each reusable bag returned. It also debits the account of shopper for reusable bags provided to shopper or used to package products purchased through the e-commerce system.

### RELATED APPLICATIONS

This application claims the benefit of U.S. Provisional Patent Application No. 62/468,211, filed Mar. 7, 2017 and entitled “Bag Recycling Program,” the contents of which are incorporated herein in their entirety.

### FIELD

The current invention is a system for dispensing and collecting reusable bags, and more specifically to a system for dispensing and collecting non-allergenic and standard reusable bags.

### BACKGROUND

Shoppers currently use plastic or paper disposable bags to carry products they have purchased from a store, such as a grocery store, to their vehicle and home. These bags are typically disposed once the products reach their destination (the shopper's home). Even though there is some recycling of these disposable bags, the vast majority are not recycled.

On-line purchase of products, such as groceries, is becoming increasingly popular. These services typically prepackage the products for pickup, typically in disposable bags. Even orders of one or two items are placed in disposable bags. This adds to the proliferation of disposable bags being disposed.

There are currently reusable bags being used to carry products home from stores. Typically, the shopper buys the reusable bags, and brings them when they return to the store to shop. Many of the shoppers who want to use reusable bags, indicate that they forgot to bring their reusable bags to the store. They typically resist buying additional reusable bags, since they have reusable bags at home and will not be able to return them and receive a refund of their purchase price. These shoppers typically use disposable bags.

Though it is not a large percentage, a few shoppers have allergies or other adverse reactions to certain kinds of fabrics and materials. Current means of dispensing reusable bags do not take allergies into account and therefore, some shoppers cannot use the reusable bags.

Also, current systems for providing reusable bags did not test the bags for usefulness and cleanliness, causing some shoppers to prefer disposable bags to unclean, smelly or ripped reusable bags.

Currently, there is a need for a system in which a shopper can use reusable bags, even when they forget to bring them to the store, for both in-store purchases and on-line purchases.

### BRIEF SUMMARY

According to aspects of the present inventive concepts there is provided an apparatus and method as set forth in the appended claims. Other features of the inventive concepts will be apparent from the dependent claims, and the description which follows.

The current invention may be embodied as a system to promote use of reusable bags to carry products purchased by a shopper having a user interface adapted to receive user input from shopper, a bag receiver which receives reusable bags, an authentication device coupled to the bag receiver adapted to determine if the bag is authentic, and a tester coupled to the authentication device for receiving authenticated bags and checking each bag to verify it is usable.

It also includes a sanitizing device coupled to the tester adapted to receive usable bags and sanitize them, a standard bag storage, adapted to receive and store standard bags, and a non-allergenic bag storage adapted to receive and store non-allergenic bags.

A sorter is coupled to the sanitizing device, and is adapted to determine if a sanitized bag is a normal bag or a non-allergenic bag and store the sanitized bag in the appropriate storage.

A bag provider is adapted to provide a reusable bag when a shopper requests a reusable bag, and the shopper has elected to participate in the reusable bag recycling program, the reusable bag being provided from the non-allergenic storage if the shopper has indicated that he/she has allergies, and the reusable bag being provided from the standard bag storage if the shopper has not indicated that he/she has allergies.

The system also includes an account database adapted to store information relating to a plurality of accounts, and a CPU coupled to the user interface and the account database adapted to receive user input from shopper to identify if the shopper has elected to participate in a reusable bag recycling program, identify if the shopper has any allergies, identify an account in the account database corresponding to the shopper, credit the user's account when a reusable bag is received, and debit the account when a reusable bag has been provided to the shopper.

The current invention may also be embodied as a method of providing reusable bags to a shopper following the steps of receiving user input from a shopper electing to participate in a reusable bag recycling program, indicating if the shopper plans to return reusable bags. If the shopper does not plan to return any reusable bags, then the shopper selects products to purchase, pays for the selected products, and loads the products in bag, completing the method.

If the shopper plans to return the reusable bags, then the reusable bag is processed, and the account associated with shopper is credited for the amount associated with a reusable bag. Next the system requests if user requires new reusable bags, and if not, the method is completed.

If the shopper requests another reusable bag, a reusable bag is dispensed from bag dispenser, and the account associated with the shopper is debited, the shopper selects products to purchase, the shopper pays for the selected products, loads the selected products into the reusable bags, and completes the method.

The current invention may also be embodied as a system to promote use of reusable bags to carry products purchased by a shopper, having a personal computing device that interacts with a bag dispenser adapted to receive, store and dispense reusable bags and an ecommerce system.

The personal computing device is adapted to connect to an e-commerce system, receive user input to determine if the shopper decides to participate in a reusable bag recycling program, receive user input indicating if the shopper has an allergy, receive user input to select products on the e-commerce system to purchase, and purchase the selected products on the e-commerce system.

The bag dispenser is adapted to receive, store and dispense reusable bags and includes a communication device adapted to communicate with the personal computing device, a bag receiver which receives reusable bags, an authentication device coupled to the bag receiver adapted to determine if the bag is authentic, a tester coupled to the authentication device for receiving authenticated bags and checking each bag to verify it is usable, and a sanitizing device coupled to the tester adapted to receive usable bags and sanitize them.

The bag dispenser also includes a standard bag storage, adapted to receive and store normal bags, a non-allergenic bag storage adapted to receive and store non-allergenic bags, a sorter, coupled to the sanitizing device, adapted to determine if a sanitized bag is a normal bag or a non-allergenic bag and store the sanitized bag in the appropriate storage. The bag dispenser also includes an account database adapted to store information relating to a plurality of accounts, a bag provider coupled to the CPU, adapted to provide a standard or non-allergenic bag when it receives the proper request, a CPU coupled to the communication device and the account database adapted to interact and receive user input to identify an account in the account database corresponding to the user, and to credit the user's account when a bag is received, identify if the shopper should receive a standard bag or non-allergenic bag, and cause the bag provider to provide one of the standard bag and non-allergenic bag to be filled with the purchased products.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale; emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

FIG. 1 illustrates one embodiment of a system for dispensing and collecting reusable bags for transporting purchased items according to the current invention.

FIG. 2 is a flowchart illustrating an embodiment of a method for dispensing and collecting reusable bags for transporting purchased items according to the current invention.

FIG. 3 is an illustration of the steps involved in the step of processing returned bags of FIG. 2.

FIG. 4 is an illustration of the steps involved in the step of crediting the account of a shopper of FIG. 2.

FIG. 5 illustrates another embodiment of a system for dispensing and collecting reusable bags for transporting purchased items according to the current invention.

### DETAILED DESCRIPTION

### Theory

Currently, there are several ways to purchase products. The standard method of shopping involves physically driving to a store, selecting products to purchase, paying for them at a cash register, bagging them and then carrying the bagged products to a vehicle to take them home. The standard method currently uses many disposable bags and some reusable bags, totes, containers, packaging, etc. but for the sake of simplicity in the remainder of this document, they shall be referred to collectively as “bags” and “reusable bags”. The intent is to increase the use of reusable bags.

However, there are now several other methods of purchasing products. A second method of purchasing products is very similar to the standard method of shopping, except that payment may be made by using a personal computing device, such as a smartphone, to run an app, scan a barcode identifying the selected products to be purchased, and authorizing the debit of a payment account, such as a credit card account. This saves the shopper time by not requiring them to wait in a check-out line to pay for the selected products at a cash register.

A third method of purchasing products involves using a computing device, such as a smartphone, laptop computer, desktop, or similar device, which may be at a remote location, to connect to a website to select the products to purchase and pay for the products on-line. These products are then packaged at the store. The shopper then physically drives to the store and picks up the prepackaged products to take them home.

A fourth method of purchasing products involves using a computing device to connect to a website to select and purchase products on-line as described above for the third method. However, after the store packages the products, the store employees also deliver the products to the shopper's location (home).

In the first two methods, the shopper may bring a reusable bag with them to a store or obtain reusable bags at the store.

In the third and fourth methods above, the two on-line purchase methods, the products selected are packaged at the store by the store associates. These can be packaged in reusable bags, if set up in advance by the shopper.

In the first three methods, the shopper may bring reusable bags to be returned for credit to the store.

In the fourth method, the shopper does not go to the store's location to pick up the purchased products, but a store associate delivers them. Therefore, the shopper must give the reusable bags to the store associate to return the reusable bags 5.

### Implementation

The current invention may be implemented and described in several different ways. It will be implemented and described in terms of a ‘standard’ shopping method as a first method. It will also be described in terms of a ‘scan to purchase’ method as the second method, an ‘online purchase’ method as the third method, and an ‘online purchase/delivery’ method as the fourth method.

### ‘Standard Purchase’—Method 1

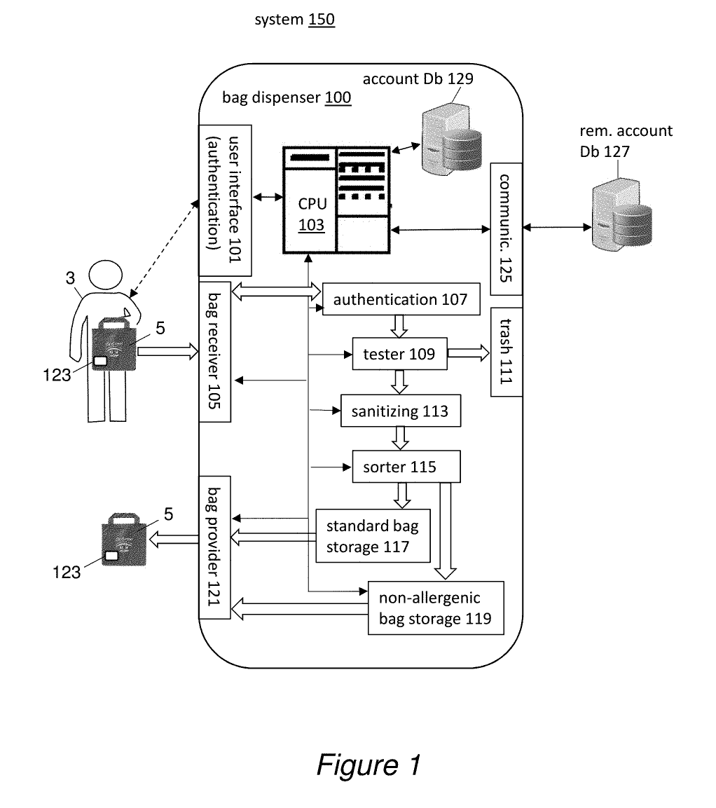

FIG. 1 illustrates one embodiment of a system for dispensing and collecting reusable bags for transporting purchased items according to the current invention.

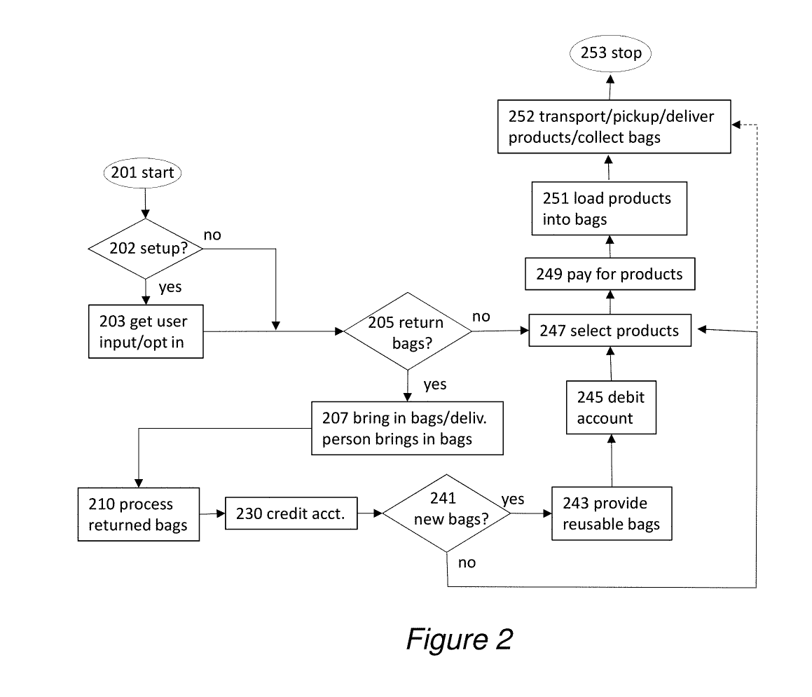

FIG. 2 is a flowchart illustrating an embodiment of a method for dispensing and collecting reusable bags for transporting purchased items according to the current invention.

The current invention will be described in connection with FIGS. 1 and 2 for the standard purchase method, method one. The method begins at step 201. A shopper 3 enters a store. If the shopper 3 has not yet signed up for the bag recycling program, the shopper then goes to a customer service desk to set up, or ‘opt in’ to a bag recycling program. A store associate at the customer service desk, which may be a store employee, receives user input from shopper 3 and in step 203, enters it into a CPU 103 through a user interface 101. This will include information identifying the shopper 3, and the consent of shopper 3 to agree to accept the terms of the recycling program, accepting the option to participate in the reusable bag recycling program (‘opting in’).

If shopper 3 has already set up the bag recycling program (“no”) in step 202, shopper 3 skips step 203 and returns any reusable bags 5 to the store in step 207.

In an alternative embodiment, a bag dispenser 100 has a user interface 101 that is adapted to display information to shopper 3. Shopper 3 is also allowed to input information into user interface 101 directly, without the need for a store associate. Shopper 3 therefore can interact with CPU 103 through user interface 101 to provide information required to set up the reusable bag recycling program.

The elements shown and described here for bag dispenser 100 maybe in a single kiosk-type device, or they may be separate elements at different locations in the store or other remote areas.

In step 205 shopper 3 decides if they would like to return any reusable bags 5. If shopper 3 decides not to return any reusable bags 5 (“no”) then shopper 3 select products in step 247, pays for the products in step 249 and loads the purchased products into the reusable bags 5 in step 251 to transport the products home. This process then ends at step 253.

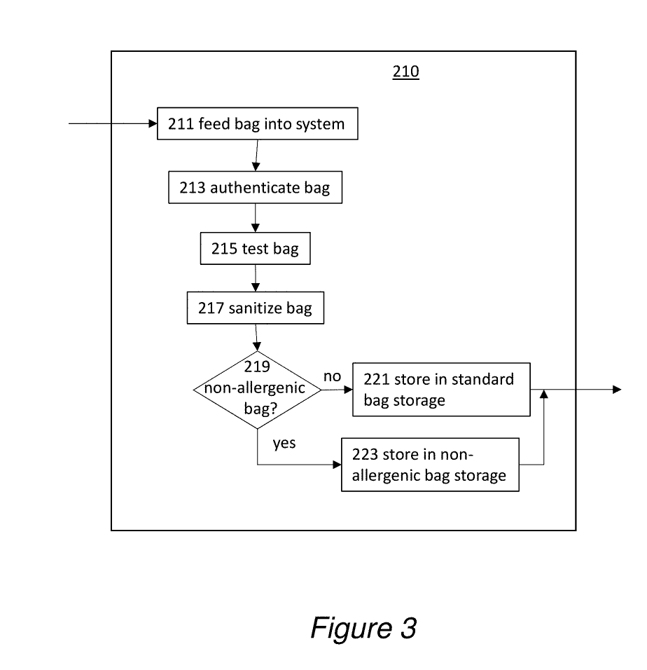

If shopper 3 decides to return reusable bags 5 in step 205 (“yes”), then shopper 3 brings in reusable bags 5. The reusable bags 5 are processed in step 210. This step is shown in greater detail in FIG. 3, and described in more detail below.

In step 241, CPU 103 displays on the user interface 101 a message asking shopper 3 if he/she would like another reusable bag 5. If shopper 3 does not indicate that he/she would not like another reusable bag (“no”) the process continues at step 247.

If shopper 3 indicates that he/she would like another reusable bag 5, (“yes”), CPU 103 determines if shopper 3 has indicated that he/she has any allergies.

If CPU 103 does not find any information for shopper 3 indicating that he/she has allergies, in step 243, CPU 103 causes standard bag storage 117 to provide a standard bag to bag provider 121 to provide to shopper 3.

If shopper 3 has indicated that he/she has an allergy, in step 241, CPU 103 causes non-allergenic bag storage 119 to provide a non-allergenic bag to bag provider 121 which in turn provides it to shopper 3.

In step 245, the account of shopper 3 is debited for each reusable bag 5 dispensed to the shopper 3.

The shopper 3 then takes the reusable bags 5 and shops, selects products in step 247, and pays for the products in step 249. Then, in step 251, the shopper 3 loads the purchased products in the reusable bags 5. The process then ends at step 253.

FIG. 3 is an illustration of the steps involved in the step of processing returned bags 210 of FIG. 2. In step 211, a reusable bag 5 is fed into the bag receiver 105 of bag dispenser 100. An authentication device 107 determines if reusable bag 5 is a bag which is compatible with bag dispenser system 100. This may be done by reading an identifier 123 attached to reusable bag 5. Identifier 123 may be markings on the bag, such as a bar code or QR code, it may be an RFID device that transmits information to an RFID reader, or any conventionally known device for identifying the reusable bag 5.

If authentication device 107 determines that the reusable bag 5 is not compatible, it returns the reusable bag 5 to the bag receiver 105 which provides it back to shopper 3.

Authentication device 107 also causes CPU 103 to display a message on user interface 101 indicating that this bag is not one that is compatible with system 100.

In step 215, a tester 109 tests the integrity of the returned reusable bag 5. This tests the returned reusable bag 5 for rips, holes, weakened portions and/or missing structures, such as straps. Those reusable bags which have holes, rips, are missing structures or are otherwise unusable, are sent to a trash device 111 for disposal.

In step 217, a sanitizing device 113 may also clean and sanitize reusable bags 5 that are determined to be usable, for reuse.

In step 219, a sorter 115 determines if the reusable bag 5 is a non-allergenic bag, or a standard bag.

In step 221, standard bags are stored in standard bag storage 117. In step 223, non-allergenic bags are then stored in non-allergenic bag storage 119.

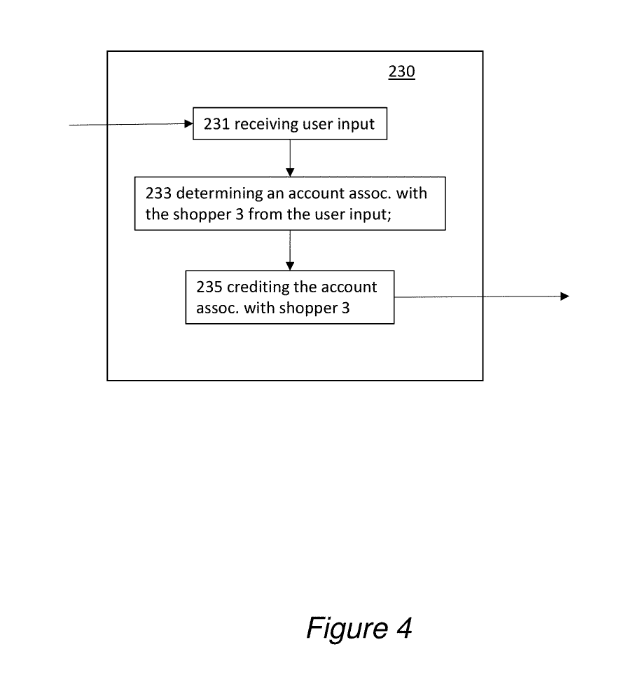

FIG. 4 is an illustration of the steps involved in the step of crediting the account of a shopper, step 230 of FIG. 2.

In step 231, CPU 103 receives information (user input) from shopper 3 through user interface 101.

In step 233, CPU 103 determines an account that is associated with shopper 3.

In step 235, if the reusable bag 5 returned by shopper 3 is acceptable, the account of shopper 3 is credited with the return of the reusable bag 5 in an account database 129.

In an optional embodiment, the account information for shopper 3 may be held in a remote location, such as in a remote account database 127.

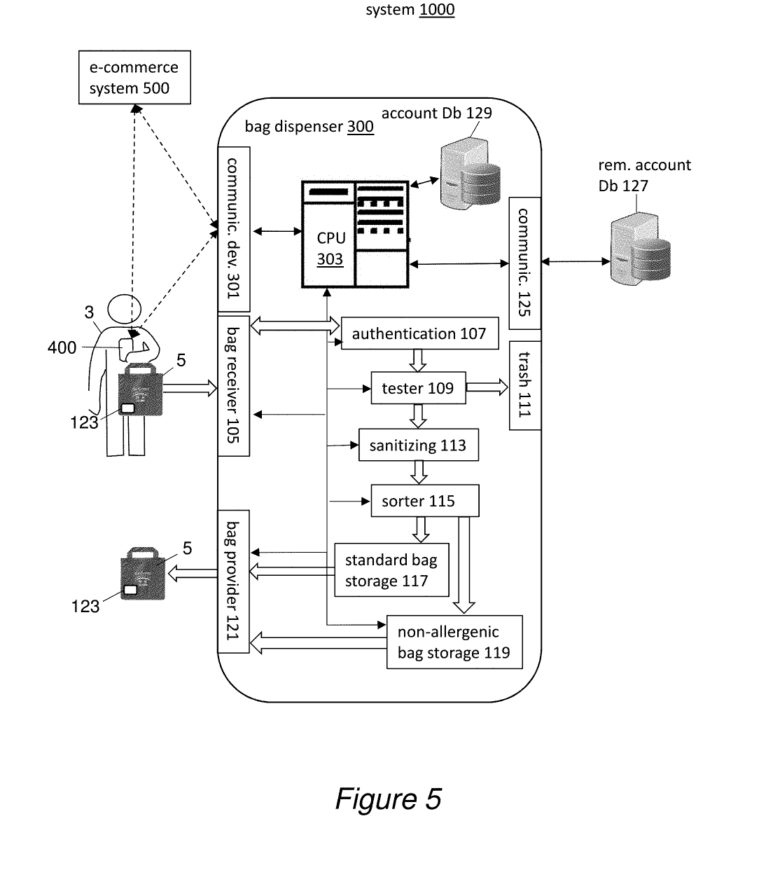

FIG. 5 illustrates another embodiment of a system for dispensing and collecting reusable bags for transporting purchased items according to the current invention. All of the elements which share the same reference numbers perform the same functions across the several figures.

The current invention will be described in connection with FIGS. 2 and 3 for the ‘Scan to Purchase’—method 2, ‘On-line Purchase/Pick-up’—method 3, and the ‘On-line Purchase/Delivery’—method 4.

### ‘Scan to Purchase’—Method 2

In the ‘Scan to Purchase’—method 2, the process starts in step 201. As with the ‘Standard Purchase—method 1 above, shopper 3 may choose in step 202 to go through set-up step 203 to “opt in” to the reusable bag recycling program.

In step 205, shopper 3 decides if he/she would like to return some reusable bags 5.

If so, (“yes”), shopper 3 then brings reusable bags 5 to a store with a dispensing unit 300.

In this embodiment, shopper 3 has a personal computing device 400 which is preloaded with a small program, an App, which is compatible with bag dispenser 300. Personal computing device 400 communicates wirelessly through communication device 301 to CPU 303 of dispensing unit 300. A user interface on personal computing device 400 interacts with shopper 3 in a manner similar to that described for user interface 101 of FIG. 1. Personal computing device 400 may now receive user input from shopper 3 and provide it to CPU 303 as well as CPU 303 providing information to shopper 3 through personal computing device 400.

Shopper 3 can then return the bag 5 to dispensing unit 300 and receive a reusable bag 5 from bag provider 121 dispensing unit 300, in a method similar to that described for the ‘Standard Purchase’—method 1, above. This method will have steps similar to that of steps 202 through 247 of FIG. 2.

Unlike ‘Standard Purchase—method 1’, this method of purchase allows the shopper 3 to pay for products using the personal computing device 400. The personal computing device 400 has a camera and an App that has the ability to scan and read various identification markings on packaging of the product. For example, computing device 400 may be able to read barcodes, QR codes or other markings to identify the product being purchased.

Once the product is identified, the computing device 400 can communicate with CPU 303 dispensing unit 300 to find an account in account database 129 of shopper 3, and then debits the account in step 245 for the purchase.

Shopper 3 is then allowed to select products in step 247, pay for products in step 249 and load the purchased products into reusable bags 5 in step 251 to transport them home. The process ends at step 253. This allows the shopper 3 to skip checkout lines at the cash register and walk out the door with his/her products in reusable bag 5.

FIG. 5 illustrates another embodiment of a system for dispensing and collecting reusable bags for transporting purchased items according to the current invention.

The current invention will be described in connection with FIGS. 2 and 5 for the ‘On-line Purchase/Pickup—method 3 and ‘On-line Purchase/Delivery—method 4.

### ‘On-Line Purchase/Pickup’—Method 3

The method begins at step 201. A shopper employs his/her personal computing device 400 to contact an e-commerce system 500. In step 202, the shopper 3 indicates if he/she has not yet signed up for the bag recycling program and would like to (“yes”).

The shopper 3 can use personal computing device 400 to connect through communications device 301 to CPU 303 to ‘opt in’ to the reusable bag recycling program in step 203.

If shopper 3 has already set up the bag recycling program (“no”) in step 202, shopper 3 skips step 203.

Shopper 3 determines in step 205 if he/she has any reusable bags 5 to return.

The elements shown and described here for bag dispenser 300 may be in a single kiosk-type device, or they may be separate elements at different locations in the store or other remote areas.

If shopper 3 decides not to return reusable bag 5 (“no”), then shopper 3 shops for products on-line, selects products in step 247 on-line, and pays for the products on-line, in step 249.

CPU 303 check the account database 129 to see if the shopper 3 has previously opted into the reusable bag recycling program, and if so, the items purchased by shopper 3 on-line are loaded into reusable bags 5 at the store. The account of shopper 3 is debited for the reusable bags.

The shopper then goes to the store, picks up the purchased products in the reusable bags 5 and transports them home.

This process then ends at step 253.

When shopper 3 is in the store, he/she can decide to return reusable bags 5 (‘yes”) in step 205.

Shopper 3 then provides the reusable bags 5 to bag dispenser 300 in step 207. The returned bags 5 are then processed in step 210 which is shown in greater detail in FIG. 3, and function as described above.

The account of shopper 3 is credited for the usable returned bags in step 230.

For the on-line purchasing methods, the shopper 3 does not need reusable bags 5 since the products have already been packaged in reusable bags at step 241 (‘no”), and processing continues at step 252.

In step 252, the shopper 3 picks up the pre-packaged products and transports them home.

The process then ends at step 253.

### ‘On-Line Purchase/Delivery’—Method 4

This method follows the same procedure as that for ‘On-line Purchase/Pickup’—Method 3 above with the exception that the shopper 3 does not enter the store. Products purchased on-line are delivered to the shopper 3. If shopper 3 has opted in to the Reusable Bag Recycling Program, then the products are packaged in reusable bags 5. When the products are delivered, shopper 3 can then give the person delivering the products reusable bags 5 to return to the store.

Although a few examples have been shown and described, it will be appreciated by those skilled in the art that various changes and modifications might be made without departing from the scope of the invention, as defined in the appended claims.

What is claimed is:

1. A system to promote use of reusable bags to carry products purchased by a shopper comprising:
a user interface adapted to receive user input from shopper;
a bag receiver which receives reusable bags;
an authentication device coupled to the bag receiver adapted to determine if the bag is authentic;
a tester coupled to the authentication device for receiving authenticated bags and checking each bag to verify it is usable;
a sanitizing device coupled to the tester adapted to receive usable bags and sanitize them;
standard bag storage, adapted to receive and store standard bags;
a non-allergenic bag storage adapted to receive and store non-allergenic bags;
a sorter, coupled to the sanitizing device, adapted to determine if a sanitized bag is a normal bag or a non-allergenic bag and store the sanitized bag in the appropriate storage;
a bag provider adapted to provide a reusable bag when a shopper requests a reusable bag, and the shopper has elected to participate in the reusable bag recycling program, the reusable bag being from the non-allergenic storage if the shopper has indicated that he/she has allergies, and being a reusable bag from the standard bag storage if the shopper has not indicated that he/she has allergies;
an account database adapted to store information relating to a plurality of accounts;
a CPU coupled to the user interface and the account database adapted to:
receive user input from shopper to identify if the shopper has elected to participate in a reusable bag recycling program,
identify if the shopper has any allergies,
identify an account in the account database corresponding to the shopper,
credit the user's account when a reusable bag is received, and
debit the account when a reusable bag has been provided to the shopper.

2. The system of claim 1 further comprising:
a trash device adapted to receive bags from tester which are not usable.

3. The system of claim 1 wherein the sorter passes standard bags to the standard bag storage and the non-allergenic bags to the non-allergenic bag storage.

4. The system of claim 1 wherein user interface is further adapted to acquire user input regarding allergies, and if the user input indicates an allergy, then providing a non-allergenic bag to bag provider which dispenses reusable bag to the shopper.

5. The system of claim 1 wherein the CPU uses user input to determine an account corresponding to the shopper, and debits the account for each reusable bag dispensed.

6. The system of claim 1 wherein the sanitizing device is adapted to disinfect the reusable bag.

7. The system of claim 1 further comprising:
an identification (ID) marker having an identifier attached to each bag, and;
the authentication device is further adapted to read the identifier on the reusable bag to determine if it is compatible with this system.

8. The system of claim 1 wherein the authentication device is further adapted to return the bag to the user when the authentication device determines that bag is not compatible with this system.

9. The system of claim 1 wherein the CPU is further adapted to display a message to user indicating that the bag is not compatible with this system when the authentication device determines that the reusable bag is not compatible with this system.

10. The system of claim 1 wherein the CPU credits the account associated with shopper when an authentic bag is received.

11. The system of claim 1 wherein the CPU debits the account associated with shopper when a reusable bag is provided to shopper.

12. The system of claim 1 wherein the tester determines if a bag is usable by identifying that it is free of holes, and has all required parts.

13. A method of providing reusable bags to a shopper comprising the steps of:
receiving user input from a shopper electing to participate in a reusable bag recycling program;
indicating if the shopper plans to return reusable bags, and
if not, then:
selecting products to purchase;
paying for the selected products;
loading products in bag; and
completing the method,
if so, then:
processing the returned bag;
crediting an account associated with shopper for the amount associated with a reusable bag;
requesting if user requires new reusable bags,
if not, completing the method, and
if so, then:
dispensing a reusable bag from bag dispenser,
debiting the account associated with the shopper,
selecting products to purchase,
paying for the selected products,
loading products in the reusable bags; and
completing the method.

14. The method of claim 13, wherein crediting the account comprises the steps of:
receiving user input;
determining an account from the user input; and
crediting an account associated with the user if the bag is acceptable.

15. The method of claim 13, wherein the step of processing returned bags comprises the steps of:
feeding a reusable bag into a system;
authenticating the reusable bag to determine if the reusable bag is compatible with this system;
testing if the reusable bag is acceptable to use with the system;
sanitizing the bag;
determining if the reusable bag is a non-allergenic bag or a standard bag;
storing the reusable bag in standard storage if the reusable bag is determined to be a standard bag; and
storing the reusable bag in non-allergenic storage if the reusable bag is determined to be a non-allergenic bag;

16. A system to promote use of reusable bags to carry products purchased by a shopper, comprising:
a personal computing device adapted to:
connect to an e-commerce system,
receive user input to determine if the shopper decides to participate in a reusable bag recycling program,
receive user input indicating if the shopper has an allergy;
receive user input to select products on the e-commerce system to purchase, and
purchase the selected products;
a bag dispenser adapted to receive, store and dispense reusable bags comprising:
a communication device adapted to communicate with the personal computing device;
a bag receiver which receives reusable bags;
an authentication device coupled to the bag receiver adapted to determine if the bag is authentic;
a tester coupled to the authentication device for receiving authenticated bags and checking each bag to verify it is usable;
a sanitizing device coupled to the tester adapted to receive usable bags and sanitize them;
standard bag storage, adapted to receive and store normal bags;
a non-allergenic bag storage adapted to receive and store non-allergenic bags;
a sorter, coupled to the sanitizing device, adapted to determine if a sanitized bag is a normal bag or a non-allergenic bag and store the sanitized bag in the appropriate storage;
an account database adapted to store information relating to a plurality of accounts;
a bag provider, adapted to provide a standard or non-allergenic bag when it receives the proper request;
a CPU coupled to the communication device and the account database adapted to interact and receive user input to identify an account in the account database corresponding to the user, and to credit the user's account when a bag is received; identify if the shopper should receive a standard bag or non-allergenic bag; and cause the bag provider to provide one of the standard bag and non-allergenic bag to be filled with the purchased products.

17. The system of claim 16 further comprising:
a trash device adapted to receive bags from tester which are not usable.

18. The system of claim 16 wherein the purchased products are packaged in reusable bags if the shopper participates in the reusable bag recycling program and delivered to the shopper and reusable bags are returned to the store.

19. The system of claim 17 wherein personal computing device is further adapted to:
acquire user input regarding allergies, and
if the user input indicates an allergy, then
the reusable bags used to package on-line orders for shopper and the reusable bags provided to the shopper by the bag dispenser are non-allergenic bags; else
the reusable bags used to package on-line orders for shopper and the reusable bags provided to the shopper by the bag dispenser are standard bags

20. The system of claim 16 wherein the CPU uses user input to determine an account corresponding to the shopper, and debits the account for each bag dispensed.
